(19) United States
(12) Patent Application Publication
(10) Pub. No.: US 2008/0232094 A1
(43) Pub. Date: Sep. 25, 2008

(54) Solar powered post lamp

(76) Inventor: William Sanner Ramsdell, Las Vegas, NV (US)

Correspondence Address: ROBERT F. PALERMO, ESQ., 1687 LITTLE MOUNTAIN ROAD, BETHEL, PA, 19507, US

(21) Appl. No.: 11/725,608

(22) Filed: Mar. 20, 2007

(51) Int. Cl. F21L 4/00; F21S 8/00

(52) U.S. Cl. 362/153; 362/183

(57) ABSTRACT

An electrical post lamp has a body with at least three light-transmitting sides, a base member for mounting the body on a post, and a top member for shedding precipitation and airborne dirt. The body includes a lighting element, a rechargeable battery for powering the lighting element, a photosensitive switching element for activating the lighting element during the night and deactivating the element during daylight, and a solar collector including at least one solar panel for recharging the battery during daylight. The top member incorporates the solar collector panels and is formed with a downward sloping periphery having a slope which is determined by and approximately equal to the geographic latitude of intended use of the post lamp. In appropriate cases, a mirror may be provided for reflecting sunlight onto the North-facing or South-facing portion of the solar collector on the top member.

### CROSS REFERENCE TO RELATED APPLICATIONS

Not Applicable

### FEDERALLY SPONSORED RESEARCH OR DEVELOPMENT

Not Applicable

### PARTIES TO A JOINT RESEARCH AGREEMENT

Not Applicable

### INCORPORATION-BY REFERENCE OF MATERIAL SUBMITTED ON A COMPACT DISC

Not Applicable

### BACKGROUND OF THE INVENTION

This invention relates generally to outdoor post-mounted lamps and more particularly to post mounted lamps powered by batteries rechargeable by solar energy.

Post lamps are commonly used in numerous applications to provide illumination during the night along streets, in shopping centers and strip malls, and along walkways and driveways at schools, offices, and residences. Such lamps are most often powered by electricity and require connection to the electrical power grid by electrical cable. In some residential and commercial developments, such lighting is provided by continuously burning gas lamps using natural gas or propane instead of electricity. This also requires connection to some source of fuel gas by piping. The difficulty and expense of providing and maintaining such cable or piping connections discourages provision of such illumination in many cases where it would otherwise be desirable. The cost of the energy consumed by such lighting is also considerable, presently often exceeding 200 to 300 dollars per lamp per year.

For more than thirty (30) years, there have been extensive efforts to develop alternative sources of energy, including harnessing wind energy, ocean wave and tidal energy, and solar energy. These efforts have led to the still continuing evolution of wind and sea water turbine generators, and of both thermal and photoelectric solar collectors. Since solar collector efficiency is greatest when the radiation source direction is perpendicular to the surface of the solar collector, some high-efficiency solar collectors have been provided with drive systems to adjust azimuth and elevation angles of the collector to maintain perpendicularity of the collector surface to the sun throughout the day. Such systems, however, are too costly for most private residential applications, and solar collectors are most often oriented in a direction which receives the maximum average daily radiation throughout the year.

The development and rapid improvement in semiconductor technology has made possible electrically-powered hand-held devices such as calculators which use photoelectric cells for power. This technology has enabled placement of self-contained solar powered lighting units at any location where enough solar radiation is available to charge batteries with sufficient electrical energy to power the lights. In some cases, unless the solar collector has sufficient collecting surface area, insufficient solar energy may be collected during overcast days to provide enough power to operate the light throughout the hours of darkness. To avoid this problem, solar powered lamps are typically provided with large solar collector arrays the sizes and configurations of which, in some applications, may be impractical or aesthetically objectionable. As a result, application of solar power for such lighting has been limited to locations where the solar collector arrays can be masked or otherwise shielded from view.

The foregoing illustrates limitations known to exist in present post-mounted lighting equipment. Thus, it would clearly be advantageous to provide an alternative directed to overcoming one or more of the limitations set forth above. Accordingly, a suitable alternative is provided including features more fully disclosed hereinafter.

### SUMMARY OF THE INVENTION

In one aspect of the present invention, this is accomplished by providing a solar powered electrical post lamp having a main body with a lighting element and at least three light-transmitting sides, a base member for mounting the body on a post, a top member for shedding precipitation and airborne dirt, a rechargeable battery, and a solar collector for charging the battery. The invention improves such post lights by incorporating the solar collector in the top member so that the solar panels which make-up the collector form the downward sloping periphery of the top member, the slope of which being determined by and approximating the latitude of intended use of the post lamp.

The foregoing and other aspects will become apparent from the following detailed description of the invention when considered in conjunction with the accompanying drawings.

### BRIEF DESCRIPTION OF THE DRAWINGS

FIG. 1 is a schematic perspective view of a preferred embodiment of the solar-powered post lamp of the invention.

FIG. 2(a) is a schematic view of the post lamp assembly with the top member opened to show the volume within.

FIG. 2(b) is a schematic view of a rechargeable battery for use with the lamp of the invention.

FIG. 2(c) is a schematic view showing the electronic control module of the invention.

FIG. 2(d) is a schematic view showing the solar panels separated from the top member.

FIG. 3 is a schematic view of the top member of the lamp of the invention incorporating a mirror for enhancement of solar intensity for the panel of the solar collector which faces away from the direction of the sunlight.

### INVENTION ELEMENTS SHOWN IN DRAWINGS

100—SOLAR POWERED POST LAMP
   10—TOP MEMBER
      11—TOP MEMBER BOTTOM PLATE
         11a—MIRROR HINGE EXTENSION TRACKS
      12—PERIPHERAL SOLAR COLLECTOR PANELS (FOUR)
      13—TOP MEMBER FRAME
      14—TOP SOLAR COLLECTOR PANEL
      16—TOP MEMBER CLOSURE HINGE
      17—SOLAR MIRROR
      18—SOLAR PANEL CONNECTION LEADS
      19—SOLAR MIRROR HINGE
         19a-MIRROR HINGE EXTENSION RAILS
   20—MAIN BODY
      21—MAIN BODY BOTTOM PLATE
      22—MAIN BODY FRAME
      23—PHOTOELECTRIC CELL
      24—PHOTOCELL CONNECTION LEADS
      25—LIGHTING ELEMENT
      28—LIGHTING ELEMENT CONNECTION LEADS
   30—BASE MEMBER
      32—BASE MEMBER ATTACHMENT FLANGE
      34—BASE MEMBER LAMP POST SOCKET
   50—RECHARGEABLE BATTERY
      58—BATTERY CONNECTION CABLES
   60—ELECTRONIC CONTROL MODULE
      68—ELECTRONIC CONTROL LEADS

### DETAILED DESCRIPTION OF THE INVENTION

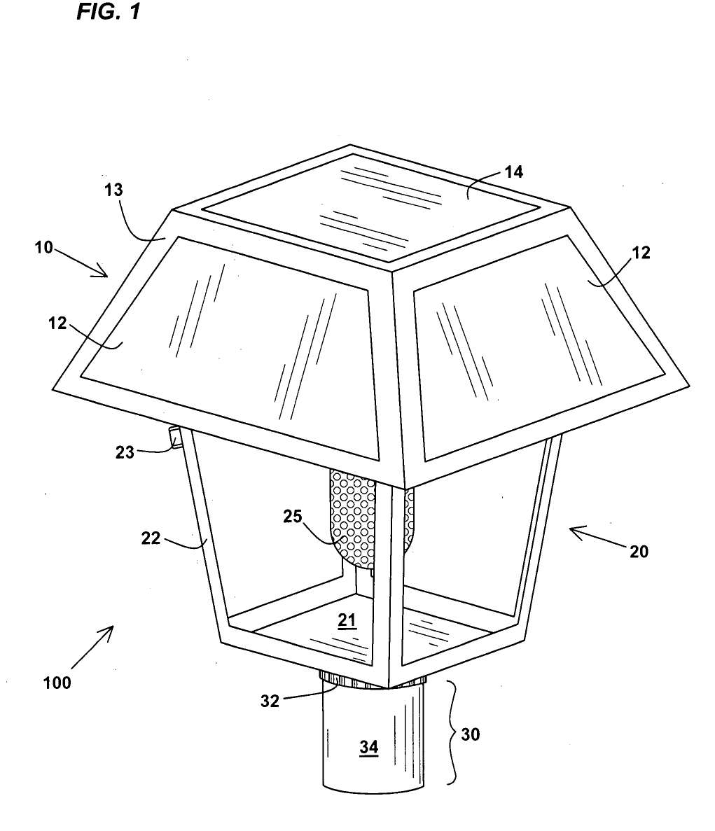

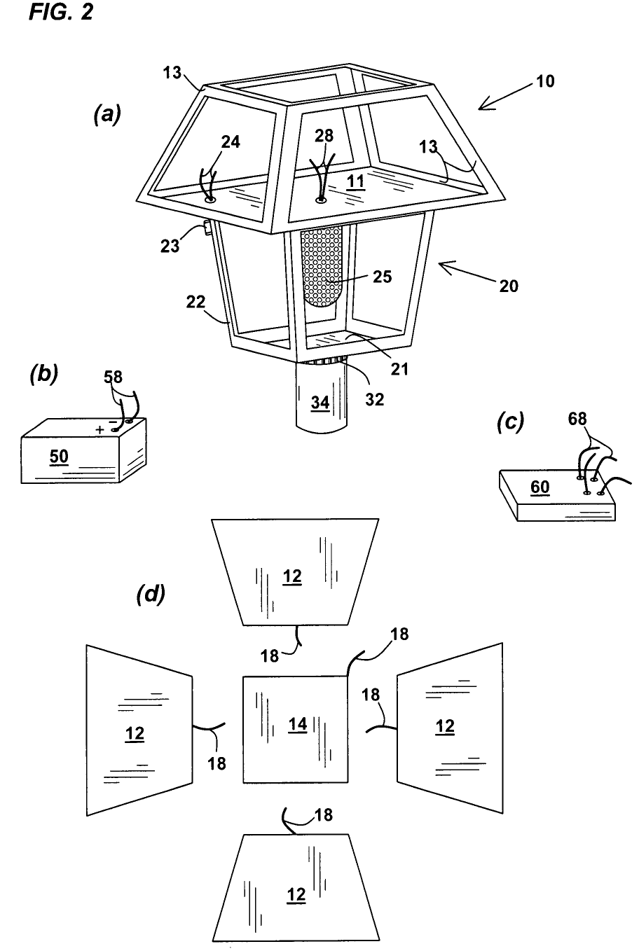

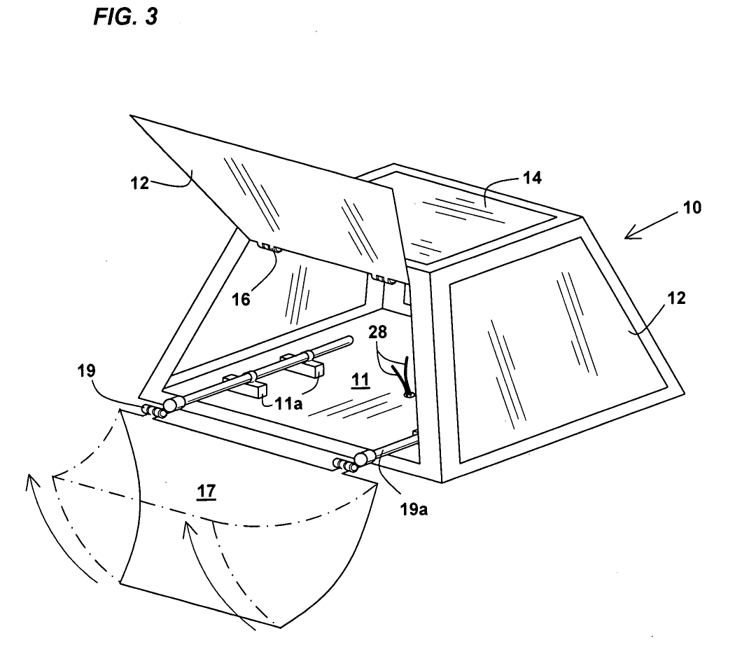

The schematic perspective view of FIG. 1 shows the solar powered post lamp 100 in one preferred embodiment having a top member 10, a main body 20, and a base member 30. The top member 10 is formed as a six-sided polyhedron with a square top solar collector panel 14, four trapezoidal peripheral solar collector panels 12, and a square top member bottom plate 11 (seen in FIGS. 2 and 3), all mounted on a top member frame 13.

The top member 10 is affixed to the lamp main body 20. The main body 20 has a main body frame 22 supporting a plurality of light transmitting side plates 24, and affixed to a main body bottom plate 21. A photocell 23 is mounted on frame 22 and senses ambient light to activate and deactivate the lighting element 25, mounted within the main body, at dusk and dawn.

Base member 30 comprises a base member lamp post socket 34 and a base member attachment flange 32. The base member attachment flange is affixed to the main body 20 and supports the lamp on a lamp post (not shown).

FIGS. 2(a)-2(d) schematically show the separate elements and subassemblies of the invention. In FIG. 2(a), top member 10 is shown to have an interior volume defined by frame 13 and bottom plate 11. The top member 10 is illustrated here as an open frame 13 upon which solar panels 12 and 14 are to be mounted, but it may also be made as an inverted deep-drawn bowl (not shown) upon which solar panels are mounted. If made as a drawn bowl, the top member 10 may be hinged to the top member bottom plate 11 to provide access for a battery and electronic control module to be mounted on the bottom plate. Lighting element leads 28 and photocell connection leads 24 are illustrated protruding from top member bottom plate 11. The interior of top member 10 is preferably used for housing other components of the lamp including battery 50 (FIG. 2(b)), and electronic control module 60 (FIG. 2(c)), and the square top surface and downward sloping trapezoidal peripheral surfaces are used for mounting solar collector panels 14 and 12, respectively (FIG. 2(d)). The solar panels 12, 14, electronic control module 60, battery 50, photoelectric cell 23, and lighting element 25 are interconnected through connection leads 18, 68, 58, 24, and 28, respectively. Solar panel connection leads 18 provide solar energy through electronic control leads 68 to electronic control module 60. The control module connects through battery connection cables 58 to recharge battery 50 until it is fully charged. It also processes signals received through photocell connection leads 24 to activate and deactivate lighting element 25, in response to ambient light levels, through lighting element connection leads 28.

Main body 20 is mounted on base member 30 which has a base member lamp post socket 34 fixed to the main body bottom plate 21 by base member attachment flange 32. The main body has a frame 22 mounted on bottom plate 21. The frame is designed to support transparent or translucent plates (not shown) around a center mounted lighting element 25 which includes at least one (1), but preferably a plurality, of light emitting diodes as determined by lighting level requirements. Lighting element 25 is shown projecting downward from the bottom plate of the top member, but in appropriate cases it may be mounted projecting upward from the main body bottom plate 21. A photoelectric cell 23 is mounted on the frame 22 and provides electrical signals to the electronic control module 60 to control lighting element 25 in response to ambient light levels at dawn and dusk.

Top member 10 is preferably formed as shown with a square top 14 and downward sloping trapezoidal sides 12 incorporating the solar collector panels. It is clear, however, that it could also be formed with a square pointed top with triangular sides, a conic top, truncated or not, or a triangular top with trapezoidal or triangular sides, or other combinations. In any case, the slope of the periphery is determined by the geographic latitude of intended application of the lamp, since solar energy is most intense when it is perpendicular to the receiving surface. For example, if the lamp is intended for localities near 300 North (or South) latitude, the periphery will have a slope between 25° and 35°, while applications near 45° would require a slope between 40° and 50°. As the demand at a particular latitude becomes large enough, it is possible to provide the slope to match exactly and thereby maximize efficiency of the solar collectors.

FIG. 3 shows one embodiment of a solar mirror 17 which may be mounted on top member 10 on the North side of the lamp for the Northern Hemisphere and vice versa for the Southern Hemisphere. When the mirror 17 is incorporated, the solar panel 12 for the North (or South) side is rotated upward on hinges 16 to allow the mirror 17 to be deployed by rotating outward on hinges 19, as illustrated. The solar panel 12 is then rotated back to the closed position to receive the solar energy reflected by the mirror 17. Mirror hinges 19 are provided with extension rails 19a which are slidably retained by extension tracks 11a to allow the mirror 17 to be moved a short distance away from the top member 10 to avoid masking of the solar radiation by the top member. The mirror is provided for use during the winter months when the elevation of the sun is lowest and masking effects of the top member are greatest.

1. In an electrical post lamp having a body with at least three light-transmitting sides, a base member for mounting said body on a post, and a top member for shedding precipitation and airborne dirt, said body containing a lighting element, a rechargeable battery for powering said lighting element, and a solar collector including at least one solar panel for recharging said battery during daylight, the improvement comprising:
said top member incorporating the at least one solar panel and being formed with a downward sloping periphery, said slope being determined by and proportional to the latitude of intended use of said post lamp.

2. The post lamp of claim 1, wherein said top member has a tetrahedral surface.

3. The post lamp of claim 1, wherein said top member is a truncated tetrahedron, the square top surface and trapezoidal side surfaces of said tetrahedron incorporating solar panels of said solar collector.

4. The post lamp of claim 1, wherein said top member has a conical surface.

5. The post lamp of claim 1, wherein said top member is a truncated cone, having a round top surface and conical side surface incorporating solar panels of said solar collector.

6. The post lamp of claim 1, wherein said top member has sufficient area to accommodate solar collector panels with sufficient area to provide sufficient electrical energy to said battery to power the lighting element for two (2) nights.

7. The post lamp of claim 1, wherein said lighting element comprises a light emitting diode.

8. The post lamp of claim 1, wherein said lighting element comprises a plurality of light emitting diodes.

9. The post lamp of claim 1, further comprising:
a photosensitive switching element for activating the lighting element during the night and deactivating said element during daylight.

10. The post lamp of claim 1, further comprising:
a mirror for reflecting sunlight onto a solar collector panel on a North-facing or South-facing portion of said top member.

11. An electrical post lamp for illuminating a walkway of a residence, said lamp comprising:
a body having three or more light transmitting sides, a base member for attachment to a support post, and a top member for shedding precipitation and dirt;
a lighting element mounted within said body for providing required illumination;
a battery for providing electrical power to said lighting element; and
means for activating and deactivating said lighting element.

12. The post lamp of claim 11, wherein said lighting element comprises at least two light emitting diodes.

13. The post lamp of claim 11, wherein said battery for providing electrical power to said lighting element is rechargeable;

14. The post lamp of claim 11, wherein the means for activating and deactivating said lighting element is a photosensitive switching device which is calibrated to activate said lighting element below a preset level of ambient light and to deactivate said lighting element above said preset level.

15. The post lamp of claim 11, further comprising:
a solar collector for providing electrical power to recharge said battery.

16. The post lamp of claim 15, wherein said solar collector forms the top member for said lamp body, said top member having a periphery sloping downward at an angle proportional to the latitude at which the post lamp is to be used.

17. An electrical post lamp for illuminating a walkway of a residence without connection to the wiring system of said residence, said lamp comprising:
a body having four (4) light transmitting sides, a base member for attachment to a support post, and a top member for shedding precipitation and dirt;
a lighting element comprising at least one (1) light emitting diode mounted within said body for providing required illumination;
a rechargeable battery for providing electrical power to said lighting element;
a photosensitive switching device for activating said lighting element below a preset level of ambient light and deactivating said lighting element above said preset level;
a solar collector for providing electrical power to recharge said battery, solar panels which make up the solar collector forming the top member for said lamp body, said top member having a periphery formed from said solar panels and sloping downward at an angle approximately equal to the latitude at which the post lamp is to be used.

18. The electrical post lamp of claim 17, wherein said solar collector has sufficient solar panel area to provide enough energy to charge the battery sufficiently to operate the lighting element for at least two nights.
